(19) United States
(12) Patent Application Publication
(10) Pub. No.: US 2020/0154769 A1
(43) Pub. Date: May 21, 2020

(54) Atomizer and Atomization Core of an Electronic Cigarette

(71) Applicant: Zhaoyang Leng, Guangdong (CN)

(72) Inventor: Zhaoyang Leng, Guangdong (CN)

(21) Appl. No.: 16/611,229

(22) PCT Filed: Mar. 29, 2018
(86) PCT No.: PCT/CN2018/080991

§ 371 Date: Nov. 6, 2019

(30) Foreign Application Priority Data
May 6, 2017 (CN) 201710314621.0

(51) Int. Cl. A24F 40/46; A24F 40/44

(52) U.S. Cl. CPC A24F 40/46; H05B 2203/021; A24F 40/44

(57) ABSTRACT

Disclosed is an atomizer of an electronic cigarette, the atomizer including an airflow channel, a conductive line, an oil storage apparatus and an atomization core, wherein the atomization core comprises a liquid seepage member, an electric heating body and an atomization core housing, the liquid seepage member and the electric heating body are arranged in the atomization core housing, and the liquid seepage member is in communication with the oil storage apparatus; the airflow channel is in communication with the atomization core; the oil storage apparatus is an oil storage bottle; the oil storage bottle is integrally formed; a bottle cover is arranged on the oil storage bottle, and the bottle cover comprises a gas guide conductive pipe arranged under the bottle cover; the atomization core is detachably connected to the gas guide conductive pipe; the atomization core is arranged in the oil storage bottle; and the conductive line is conducting to the electric heating body from the bottle cover.

### TECHNICAL FIELD

The present invention relates to the technical field of electronic cigarettes, and more particularly to an atomizer of an electronic cigarette.

### BACKGROUND ART

In recent years, with the development of science, technology and society, people gradually recognize the harm of smoking tobacco to the body. Smoking tobacco is gradually restricted and even prohibited in some occasions to avoid the impacts on people's physical health and surrounding environment. However, due to most smokers' addiction to smoking, it is not easy to quit smoking completely. Then an electronic cigarette product comes out, which can atomize nicotine-containing liquid by electric heating, currently popular on the market. To meet the needs of smokers by enabling them to smoke the mist, the product tends to replace tobacco in some cases.

The invention in patent application of no. 2016108947526 provides an oil storage bottle with an oil leakage prevention atomization core, comprising: an oil storage bottle, an oil filling valve, an atomization core and an outer sleeve of atomization core, wherein the outer sleeve of atomization core is arranged under a bottle opening of the oil storage bottle; the oil filling valve is connected with a bottle opening and an outer sleeve of atomization core; the atomization core arranged internally is connected with the outer sleeve of atomization core by sliding. An atomization core comprises an oil inlet pipe, an oil conducting non-woven fabric and the heating wire; on the side wall of the oil inlet pipe are arranged oil inlet holes and oil outlet holes; the oil inlet hole is arranged above the oil outlet hole; the oil conducting non-woven fabric is sleeved at the position of the oil outlet hole on the outer wall of the oil inlet pipe; the heating wire is wound round the outer wall of the oil conducting non-woven fabric. By arranging the oil storage bottle and the oil filling valve, the tobacco tar can be conveniently stored and carried; by arranging the atomization core comprising an oil inlet pipe, an oil conducting non-woven fabric and a heating wire, oil leakage from the atomization core is prevented, and meanwhile the oil conducting rate is improved, the structure of the atomization core is simplified, and the design of an oil circuit is facilitated. The defects of the device structure are as follows: (1) the oil storage bottle is always inverted with the bottle opening facing downwards that oil leakage of the smoke tar is inevitable; (2) for oil filling, the oil storage bottle needs to be inverted before being taken down, which is time-consuming and the smoke tar is prone to dripping.

The invention in patent application of no. 2016208046830 provides a disposable oil-gas channel separating oil bottle with an atomization core, comprising: a bottle body and a middle tube, wherein the middle tube is inserted into the bottle body and the top of the middle tube extends out of a bottle opening; the outer wall of the middle tube is hermetically connected with the bottle opening of the bottle body; on the top of the middle tube is a atomizing chamber in which the atomization core is arranged; the part of the middle tube inserted into the bottle body is an oil conducting tube where oil guide cotton is internally arranged; the atomization core comprises an electric heating body and oil guide cotton; the oil guide cotton of the atomization core is connected with that inside the oil conducting tube; on the side wall of the atomizing chamber an air inlet end is provided and on the top a stack nozzle is provided; by arranging the bottle and the middle tube, on the top of the middle tube there is a atomizing chamber where the atomization core is internally arranged; the part of the middle tube inserted into the bottle body is an oil conducting tube where the oil guide cotton is internally arranged, which retains the atomization core structure while storing the tobacco tar, facilitates using the oil bottle while improving the portability, and achieves the separation of oil passage and air passage thus greatly saving the space of the oil storage bottle. However, the defects of the device are as follows: (1) since the integral oil circuit is to diffuse from bottom to top and it is slow to overcome the gravity on the oil circuit, the time of oil conducting will be long; (2) it will be slow that once the tobacco tar is used up, new tobacco tar to be replaced with different flavors cannot be immediately experienced; (3) since the integral oil circuit is to diffuse from bottom to top, when the tobacco tar is less and the liquid level is lower, it will be quite difficult to transmit oil through the oil guide cotton, and a great waste of tobacco tar will be caused if the oil storage bottle is disposable.

### SUMMARY

The target of the present invention is to provide an atomizer and atomization core of an electronic cigarette so that issues raised in the above two patents can be solved.

The present invention adopts the following technical plans: an atomizer of an electronic cigarette, comprising: an airflow channel, a conductive line, an oil storage apparatus and an atomization core, wherein the atomization core comprises a liquid seepage member, an electric heating body and an atomization core housing; the liquid seepage member and the electric heating body are arranged in the atomization core housing; the liquid seepage member is in communication with the oil storage apparatus; the airflow channel is in communication with the atomization core; the oil storage apparatus is an oil storage bottle which is integrally formed and a bottle cover is arranged on the oil storage bottle; the bottle cover includes a gas and electricity conducting tube arranged below; the atomization core arranged in the oil storage bottle is detachably connected with the gas and electricity conducting tube; the conductive line is conducting to the electric heating body from the bottle cover; the conductive line is conducting to the electric heating body from the bottle cover, then the electric heating body is transmitted back to the bottle cover through the gas and electricity conducting tube to complete a loop and the air guide conductive pipe completes the loop butt joint of air inlet and air outlet of an atomization core.

The principles of an atomizer of an electronic cigarette are as follows: wherein a bottle cover is arranged on the oil storage bottle; the bottle cover comprises gas and electricity conducting tube arranged under the bottle cover; the atomization core housing is detachably connected with the gas and electricity conducting tube; the atomization core is not externally connected with any components except the gas and electricity conducting tube; the oil storage bottle is used as an individual integrated oil storage apparatus and the oil storage bottle is likely to be used as a disposable article, which is different from the oil storehouse, the oil storage chamber and the like in the prior art. An atomization core is arranged inside the oil storage bottle that will be submerged by the tobacco tar inside the oil storage when working; the tobacco tar can pass through oil inlet holes on the atomization core housing to infiltrate the liquid seepage member that the atomization core can quickly get into running; the gas and electricity conducting tube comprises a first pipe and a second pipe where the first pipe is arranged inside the second pipe and the breather pipe formed between the first pipe and the second pipe. The functions of the gas and electricity conducting tube are to electrify the electric heating body of the atomization core as well as guiding air for the atomization core, so that the conduction, the air guide and the oil guide all occur through the atomization core; the gas and electricity conducting tube is also arranged below the bottle cover, which can both conduct electricity and guide air. In this condition the oil storage bottle can only store oil by being sealed with the bottle cover without the function of conducting electricity and guiding air; the opening of the oil storage bottle can be made into disposable consumables, conveniently for replacement and use. As for the specific embodiment, the gas and electricity conducting tube can conduct electricity in the instance that the conductive line is arranged inside the first and second pipe or in the instance that the two pipes are made of conductive materials; the atomization core integrates electrical conduction, gas guiding and oil guiding, so that the atomization core becomes a vulnerable element; the atomization core housing and the gas and electricity conducting tube can be detachably connected in a threaded connection mode, a clip connection mode or other modes, so that the atomization core can also be made into disposable consumables.

The atomization core used in the atomizer of electronic cigarette of the present invention integrates functions of conducting electricity, guiding air, transmitting oil and being detached, which can be achieved by providing an atomization core for the atomizer of electronic cigarette. The atomization core comprises a liquid seepage member, an electric heating body, and an atomization core housing where an inner tube is internally arranged, at the bottom of the inside inner tube is arranged the shim block; the wall of the inner tube is provided with a long strip opening, and inside the inner tube is arranged an electric heating body and a liquid seepage member; the atomization core housing and the inner tube are respectively distributed with first oil inlet holes and second oil inlet holes, the first oil inlet holes are aligned with second oil inlet holes; the liquid seepage member is arranged on the inner wall of the inner tube in a tubular shape and on the shim block; and the electric heating body is arranged inside the tubular liquid seepage member in a spring shape.

The principles of an atomization core for an atomizer of an electronic cigarette are as follows: wherein firstly the inner tube is closely attached to the inner wall of the atomization core housing and the wall of inner tube is provided with a long strip opening and second oil inlet holes, and a hollow tubular liquid seepage member that is communicated with the oil storage bottle through first and second oil inlet holes on the atomization core housing is attached to the inner wall of inner tube; the material of the liquid seepage member hereof is not limited; the long strip opening is used for air inlet and communicated with the breather pipe inside the atomizer of electronic cigarettes, so that gas can flow along the long strip opening; at the bottom of the inner tube is arranged a shim block since it is difficult for the air out of the liquid seepage member to flow inside as a result of the textured structure of it and the infiltrated tobacco tar, which aims to block up the liquid seepage member, so that the bottom of the liquid seepage member can be higher than that of the long strip opening, and the air can flow into the inner side of the liquid seepage member by passing through the intake formed at the bottom of the inner tube.

Beneficial effects of the present invention are as follows: (1) the oil storage bottle can be conveniently used as a disposable product for timely replacement; (2) the atomization core integrates functions of electrical conduction, gas guiding and oil transmission, and longer oil paths such as oil guide cotton are eliminated so that such that the reaction is more sensitive, smoke of new tobacco tar can be immediately used as soon as oil is replaced and in the meantime, it is more convenient to save the oil and little oil can be taken away when replacing the atomization core; and (3)as for replacing oil bottle and the atomization core, under normal work the oil storage bottle keeps standing all the time, which perfectly prevents oil leakage caused by inversion of the liquid storage bottle.

### DESCRIPTION OF FIGURES

FIG. 1 shows a cutaway view of an atomizer of an electronic cigarette in embodiment 1.

FIG. 2 shows a cutaway view of an atomizer of an electronic cigarette in embodiment 2.

FIG. 3 shows an exploded view of an atomizer of an electronic cigarette in embodiment 2.

FIG. 4 shows a cutaway view of an atomizer of an electronic cigarette in embodiment 3.

FIG. 5 shows a cutaway view of an atomizer of an electronic cigarette in embodiment 4.

FIG. 6 shows a cutaway view of an atomizer of an electronic cigarette in embodiment 5.

FIG. 7 shows a cutaway view of an atomizer of an electronic cigarette in embodiment 5.

FIG. 8 shows a perspective cutaway view of the cover housing and the first pipe shown in FIG. 7.

FIG. 9 is a perspective cutaway view of the cover housing and the first pipe shown in FIG. 7.

FIG. 10 is a top view of the cover housing and the first pipe shown in FIG. 7.

FIG. 11 is a partial sectional view of the gas and electricity conducting tube and the atomization core in embodiment 6.

FIG. 12 is a sectional view of the gas and electricity conducting tube in embodiment 6.

FIG. 13 is a perspective view of the atomization core in embodiment 6.

FIG. 14 is a perspective view of the atomization core for an atomizer of an electronic cigarette.

FIG. 15 is a perspective view of the housing of the atomization core for an atomizer of an electronic cigarette.

FIG. 16 is an exploded view of an atomizer of an electronic cigarette in embodiment 7.

FIG. 17 is a cutaway view of an atomizer of an electronic cigarette in embodiment 7.

### SPECIFIC EMBODIMENTS

### Specific Embodiment 1

Hereinafter, specific embodiments of the invention shall be further described with reference to the accompanying drawings.

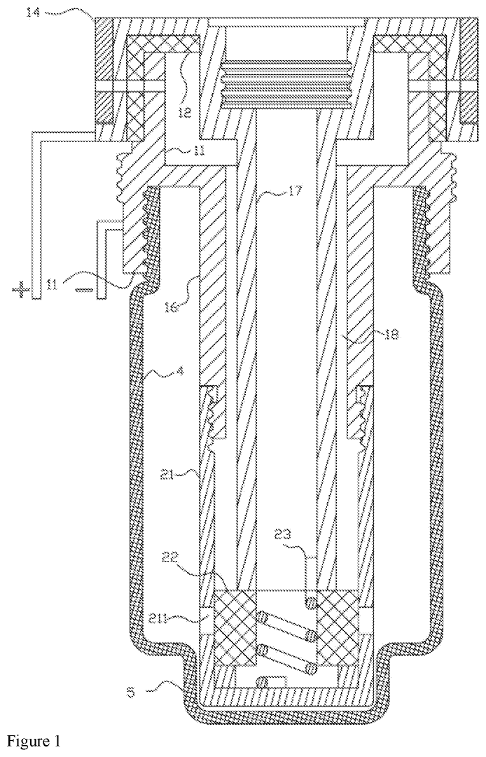

An atomizer of an electronic cigarette, as shown in FIG. 1, comprises: an airflow channel, a conductive line, an oil storage apparatus and an atomization core (2); wherein an atomization core (2) comprises a liquid seepage member (22), an electric heating body (23) and an atomization core housing (21), and the liquid seepage member (22) and the electric heating body (23)are arranged inside the atomization core housing (21); the liquid seepage member (22) is in communication with the oil storage apparatus; the airflow channel is in communication with the atomization core (2); the oil storage apparatus is an oil storage bottle (4) which is integrally formed, and a bottle cover (1) is arranged on the oil storage bottle(4); the bottle cover (1)comprises an cover housing (13), an inner cover housing (11) and the insulation layer (12), in which both the cover housing (13) and the inner cover housing 11 are made of conductive materials, and insulation layer (12) is tubular to separates the cover housing (13) and the inner cover housing (11) so that the insulation is achieved; the bottle cover(1) also includes a gas and electricity conducting tube arranged below the bottle cover (1); the atomization core housing (21) is detachably connected with the gas and electricity conducting tube; the gas and electricity conducting tube comprises a first pipe (17) and a second pipe (16), and the first pipe is arranged inside the second pipe; an airflow channel comprises the first pipe (17) and the breather pipe (18) formed between the first pipe(17) and the second pipe(16). It is shown on the figure that the breather pipe (18)is an annular breather pipe; the first pipe (17) and the second pipe(16) are also made of conductive materials; a second pipe (16)is integrally formed with an inner cover housing (11) and a first pipe (17) is integrally formed with an cover housing (13); the airflow channel comprises a first pipe (17) and a breather pipe (18), the first pipe (17) and the breather pipe (18) can reproduce the air inflow or air outgoing towards the atomization core (2); inside the oil storage bottle (4) is arranged the atomization core (2); the atomization core housing (21) is provided with oil inlet holes (211); the conductive line is conducted from the bottle cover(1) to the electric heating body(23) for heating, specifically, the cover housing (13) and the inner cover housing(11) are used for electrical conduction, and the electric heating body (23) will be electrically conductive as long as a voltage is applied between the cover housing (13) and the inner cover housing (11).

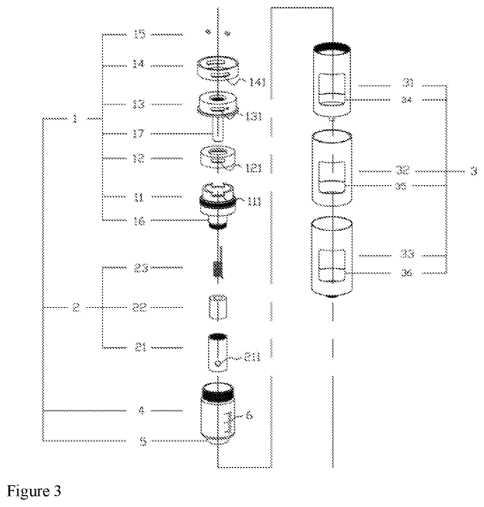

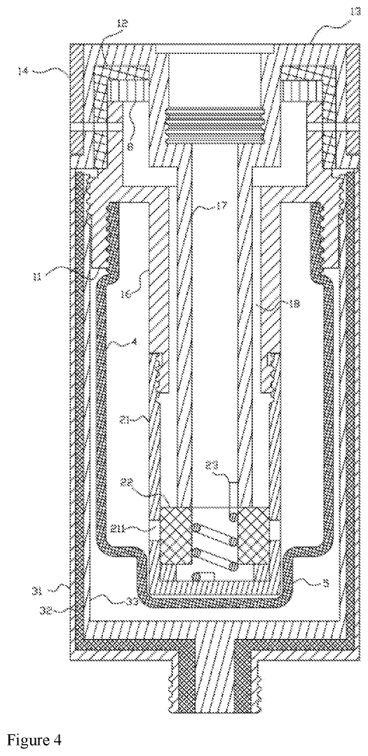

Since the embodiment 1 of bottle cover part is identical with that of embodiment 2, reference is made to FIG. 3; wherein an adjusting ring (14) is sleeved onto the cover housing (13); air inlet holes (141) are provided on the adjusting ring (14); on the bottle cover (1) is provided an air inlet end which comprises the first air inlet end(131) arranged on the cover housing (13), the second air inlet end(121) on the insulation layer(12) and the third air inlet end on inner cover housing(11); the first air inlet end(131) are aligned with both the second air inlet (121) and the third air inlet (111); the cover housing(13) is provided with a pin(15) which is inserted through air inlet holes (141) and arranged onto the cover housing (13), when used, the adjusting ring 14 can be rotated so that air inlet holes(141) are aligned with the first air inlet end(131).

The atomization core (2) in the figure is relatively simple in design, as shown in FIG. 1. Combined with FIG. 3, it indicates that the atomization core 2 is an assembly of a liquid seepage member (22), an electric heating body (23) and an atomization core housing (21); wherein the atomization core housing (21) in cylindrical shape is made of conductive materials, and screw threads are internally provided at the opening of the cylinder; two ends of the helical electric heating body (23) are provided with extensions; when it works, as shown in FIG. 1, one end of the electric heating body(23) contacts the first pipe (17) and the other end thereof contacts the bottom of the atomization core housing (21), and the electric heating body (23) will be electrically conductive whenever a voltage is applied between the cover housing (13) and the inner cover housing (11).

It should be noted that the conductive line may be any embodiment that the electric current is conducted from the bottle cover (1) to the electric heating body (23), and there are many embodiments to achieve this, such as the present embodiment in which the first pipe (17) and the second pipe (16) are made of electrically conductive materials, or adopt a wire to be directly connected with the electric heating body (23).

### Specific Embodiment 2

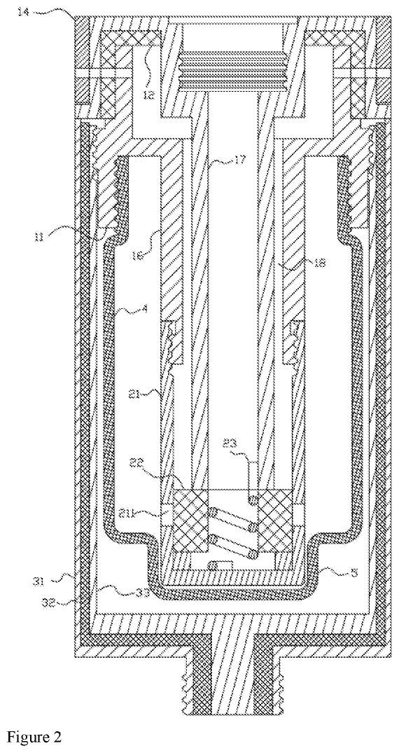

The difference between present embodiment and the embodiment 1 lies in that, as shown in FIGS. 2 and 3, below the bottle cover(1) is further arranged a cylinder shell (3), the oil storage bottle (4) is arranged inside the cylinder shell (3), and below the cylinder shell (3) is arranged a joint (7); the cylinder shell (3) comprises an outer cylinder shell (33), an inner cylinder shell (31) and an insulation tube (32);the insulating tube (32) is arranged between the outer cylinder shell (33) and the inner cylinder shell (31); the conductive line comprises the outer cylinder shell (33), the inner cylinder shell (31), the cover housing (13) and the inner cover housing (11), and the outer cylinder shell (33), the inner cylinder shell (31), the cover housing (13) and the inner cover housing (11)are all made of conductive materials; the outer cylinder shell (33) and the inner cylinder shell (31) are electrically connected with the joint (7); one end of the outer cylinder shell (33) is electrically connected with the inner cover housing (11); one end of the inner cylinder shell (31) is electrically connected with the outer cover housing (13); one end of the electric heating body (23) is electrically connected with the outer cover housing (13) and the other end of the electric heating body (23) thereof is electrically connected with the inner cover housing (11).

The conductive line in the present embodiment is from the outer cylinder shell (33), successively to the first pipe (17), the electric heating body (23), the second pipe (16), the inner cover housing (11) and then the inner cylinder shell (31); wherein the joint (7) arranged below the outer cylinder shell (33) and the inner cylinder shell (31) can be used cooperatively with a power supply; and using designs of the outer cylinder shell (33) and the inner cylinder shell (31) averts the situation that oil storage apparatus is placed inversely which is common among devices on the market, thereby fundamentally solving the problem of oil leakage.

Viewing apertures are arranged on the cylinder shell, wherein the viewing apertures comprises an inner cylinder shell (31), an insulating tube (32), and the outer cylinder shell 33 which are respectively provided with the first viewing aperture (34), the second viewing aperture (35), and the third viewing aperture (36), and in the embodiment the oil storage bottle (4) is further provided with the scale marks (6) so that the residual oil quantity can be clearly seen while used.

In the present embodiment, at the bottom of the oil storage bottle (4) is provided a concave cylinder (5), wherein the size of the concave cylinder (5)is identical with that of the bottom of atomization core housing (21), and the concave cylinder (5) wraps the bottom of the atomization core housing (21), which is used for discharging the tobacco tar inside the concave cylinder (5) so that the oil inlet holes (211) can be aligned with the bottom of the oil storage bottle (4), and then all tobacco tar in the oil storage bottle (4)can pass through the oil inlet holes (211). In this way, the tobacco tar is fully used without waste.

### Specific Embodiment 3

The present embodiment using the simulated cigarettes differs from the specific embodiment 2, wherein the airflow channel is provided with a negative pressure sensor (8) and the negative pressure sensor (8) acts as follows, when a person smokes, the negative pressure will be produced on the airflow channel so that the negative pressure sensor will be connected with a power supply to heat the electric heating body (23) and the person will experience the feeling of smog once smoking.

### Specific Embodiment 4

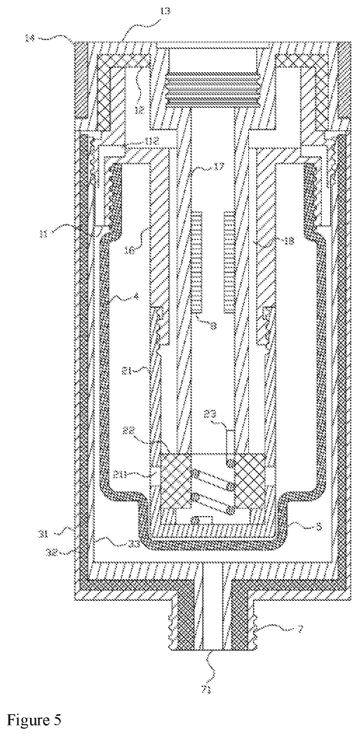

The present embodiment differs from the specific embodiment 1, wherein the airflow channel of the electronic cigarette is no longer provided with the first air inlet end (131), the second air inlet end(121) and the third air inlet end(111), as shown in FIG. 5, an inner air inlet end (112)is arranged on the inner cover housing (11); an outer air inlet end (71) is arranged on the joint (7); and the outer air inlet end(71) is communicated with the inner air inlet end(112) that communicates with the airflow channel. It can be noted from the present embodiment that the arrangement of the air flow channel in the bottle cover 1 can be varied and is not limited to any position on the bottle cover 1.

### Specific Embodiment 5

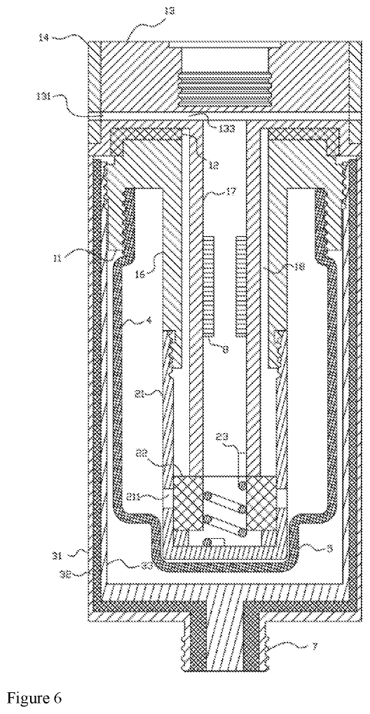

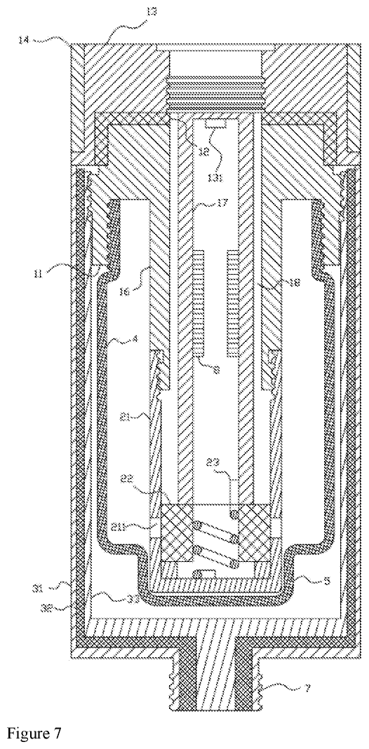

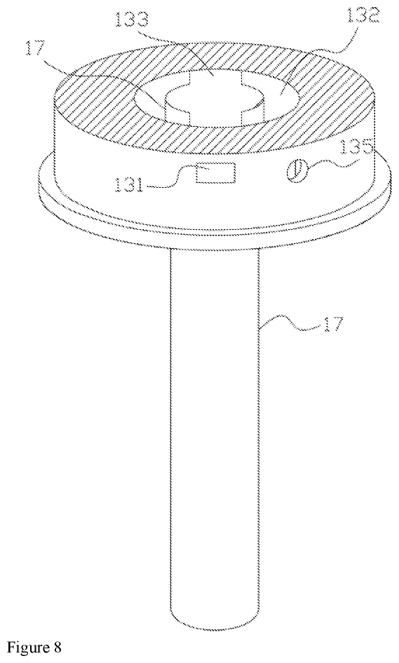

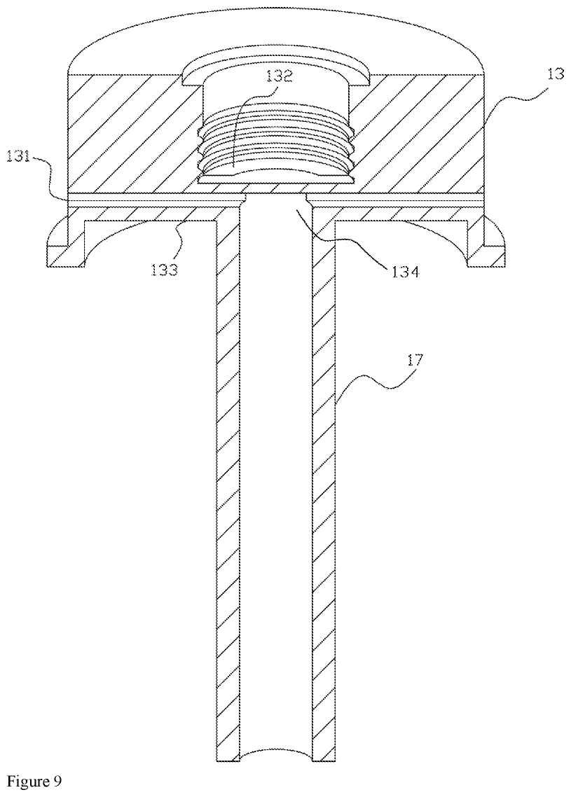

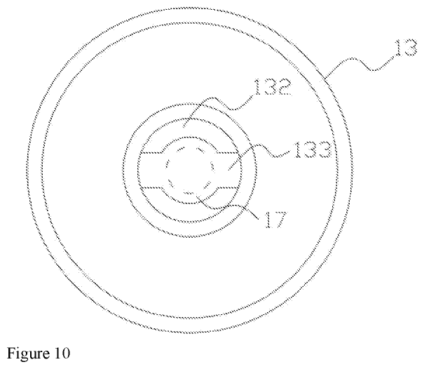

In the present embodiment, the structure that the cover housing and the first pipe is integrally formed is different from that in the embodiments 1-4, in combination with FIGS. 6-10, wherein the cutting planes of FIG. 6 and FIG. 7 are distributed in 90 degrees in space; it can be viewed that in the embodiments 1-4, the breather pipe (18) is used as an inlet pipe and the first pipe (17) is used as an outlet pipe; wherein the first pipe (17) communicates with an air inlet pipe (133), and the air inlet pipe (133) showing rectangular shape is arranged below the cover housing (13) and is communicated with first air inlet end (131); in the middle of cover housing (13)are provided air outlet holes (134); the air inlet pipe (133) passes through the bottom of the air outlet hole (134); the first pipe (17)is arranged below the air inlet pipe (133); the axis of the first pipe (17) is consistent with that of the air outlet hole (134). As can be seen from the top view of FIG. 10 in conjunction with FIGS. 8-9, after the air inlet pipe (133) passes through the bottom of the air outlet hole (134), the bottom round opening of the air outlet hole (134) is divided into two crescent-shaped and arc-shaped openings (132) which are used for discharging air, and the air in the breather pipe (18) enters the air outlet hole (134) through the arc-shaped openings (132); internal threads for connecting cigarette holders are arranged inside the air outlet hole (134). Combined with the previous five embodiments, it can be seen that the breather tube (18) and the first pipe (17) in the gas and electricity conducting tube can be used either as an inlet air duct or an outlet air duct, and that the position of the inlet end is not limited to the cover housing (13) or the inner cover housing (11).

### Specific Embodiment 6

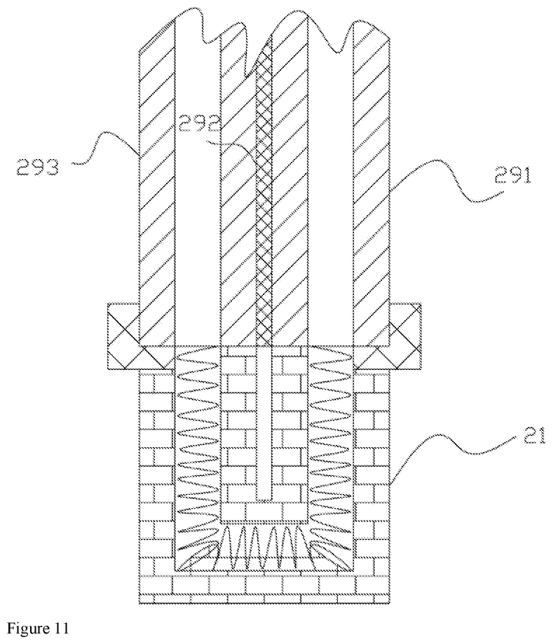

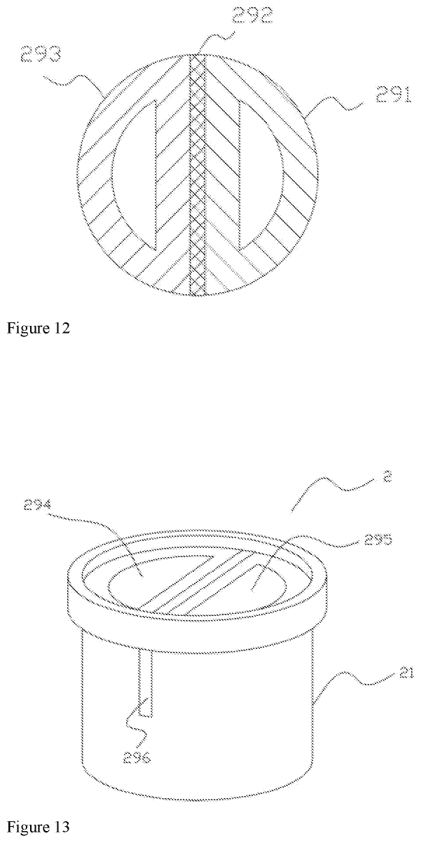

In the present embodiment, the structures of the first pipe and the second pipe of the gas and electricity conducting tube are greatly different from those in the embodiments 1 to 5; the first pipe is provided inside the second pipe in the embodiments 1 to 5 while in present embodiment the first pipe (291) is provided outside the second pipe (293), wherein the first pipe (17) and the second pipe (16)are separated similar to two semicircular long pipes; a cutaway view of the gas and electricity conducting tube as shown in FIG. 12 can be viewed that the first pipe (17), the second conduit (93) and the insulating tape (292) connecting the first pipe (17) and the second pipe (16) constitute a gas and electricity conducting tube with a circular section; as shown in FIG. 13, on the atomization core (2) are respectively provided an atomization core air inlet (294) and an atomization core air outlet (295); the first pipe (291) is connected with the atomization core air inlet (294), and the second pipe (293) is connected with the atomization core air outlet (295); the atomization core housing (21) is made of microporous ceramic; furthermore, the atomization core housing (21) is provided with a hole(296), which aims to increase the oil intake of the atomization core; as shown in FIG. 11, the section of the atomization core housing (21) is in a substantially “U” shape.

The embodiment aims to illustrate that the gas and electricity conducting tube not only has the arrangement that one tube is sleeved onto another, but also has the arrangement that one tube is arranged outside another. Thereby, in order to be distinguished from the first and second tubes in the embodiments 1-5, it is adopted that the first pipe is arranged outside the second tube; and the term “outside” may be ambiguous, but it shall be regarded to be accurate in light of the distinction between present and previous embodiments.

### Specific Embodiment 7

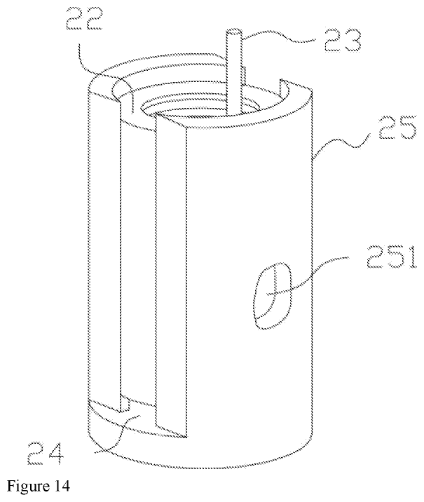

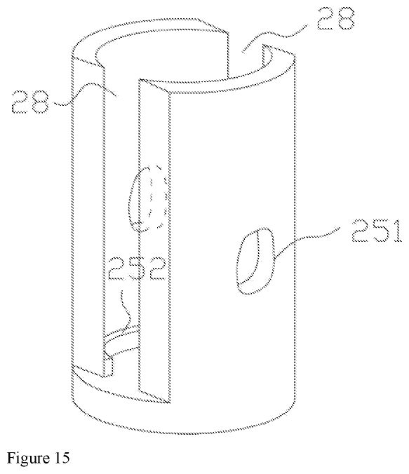

The present embodiment is further described on the basis of the specific embodiment 2, the structure of an atomization core of an atomizer for electronic cigarettes in the embodiment is as follows: as shown in FIG. 14, an atomization core (2) comprises a liquid seepage member (22), an electric heating body (23) and an atomization core housing (21); wherein the inner tube (25) is arranged inside the atomization core housing 21; as shown in FIG. 15, a shim block (252) is arranged at the bottom of the inner tube (25); the inner wall of the inner tube (25) is provided with a long strip opening, and inside the inner tube (25) is provided the electric heating body (23) and a liquid seepage member (22); first oil inlet holes (211) and second oil inlet holes (251) are respectively distributed on the atomization core housing (21) and the inner tube (25), wherein first oil inlet holes (211) are aligned with second oil inlet holes (251); the liquid seepage member (22) is attached to the inner wall of the inner tube (25) in a tubular shape and arranged on the shim block (252); and the electric heating body (23) is arranged inside the tubular liquid seepage member (22) in a spring shape.

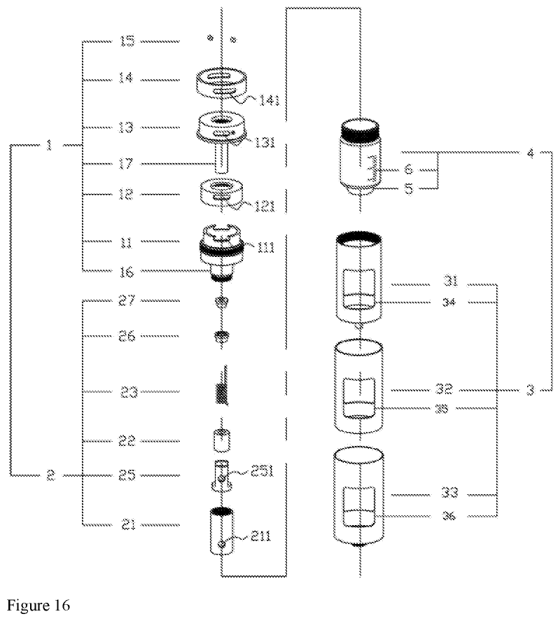

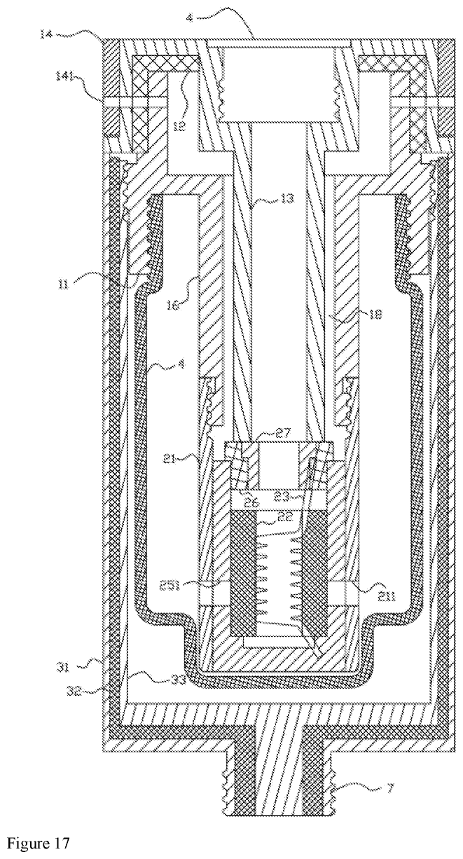

The exploded view of the embodiment is as shown in FIG. 16, the atomization core housing (21) is in threaded connection with the second tube (16), wherein both the atomization core housing 21 and the inner tube 25 are made of conducting materials with good conductive performance, so that the conductive line can conduct from the second pipe (16) to the atomization core housing (21) and the inner cylinder (25); in order to improve the air tightness inside the atomization core and avoid short circuits, the nozzle of the inner tube(25) is provided with a seal ring (26) which prevents direct communication between the inner tube and the breather pipe (18); the seal ring (26) made of an insulator is concentric to a conductive component (27), and the sealing ring (26) is tightly sleeved onto the conductive component (27); one end of the electric heating body can be inserted inside between the seal ring (26) and the conductive element (27) because the seal ring (26) is elastic, and the other end contacts the inner tube (25); when the atomization core housing 21 is screwed with the second pipe (16), the first pipe (17) is butt jointed with the conductive element (27) and then the conductive element (27) is connected with the electric heating body (23) to complete circuit conduction; the working process of the gas and electricity conducting tube is described in detail in specific embodiments 1 and 2 and will not be described in detail again.

First of all, the inner tube (25) is closely attached to the inner wall of the atomization core housing (21) and the wall of the inner tube (25) is provided with a long strip opening (28) and second oil inlet holes (251), the liquid seepage member (22) communicates with the oil storage bottle (4) through first oil inlet holes (211) and second oil inlet holes(251) on the atomization core housing(21); and the material of the liquid seepage member (22) is not limited; the long strip opening (28) is used for inletting air and communicates with the breather pipe (18) inside the atomizer of electronic cigarettes, so that gas can flow along the long strip opening (28); at the bottom of the inner tube (25) is arranged a shim block (252) since it is difficult for the air out of the liquid seepage member (22) to flow inside as a result of the textured structure of it and the infiltrated tobacco tar, which aims to block up the liquid seepage member (22), so that the bottom of the liquid seepage member (22) can be higher than that of the long strip opening (28), and the air can flow into the inner side of the liquid seepage member (22) by passing through the intake (24) formed at the bottom of the inner tube (25).

Beneficial effects of the present invention are as follows: (1) the oil storage bottle can be conveniently used as a disposable product for timely replacement; (2) the atomization core integrates functions of electrical conduction, gas guiding and oil transmission, and longer oil paths such as oil guide cotton are eliminated; the reaction is more sensitive, smoke of new tobacco tar can be immediately used as soon as oil is replaced and in the meantime, it is more convenient to save oil and little oil can be taken away when replacing the atomization core; and (3) as for replacing oil bottle and the atomization core, under normal work the oil storage bottle keeps standing all the time, which perfectly prevents oil leakage caused by inversion of the liquid storage bottle.

Finally, it should be explained that the above description is only to illustrate the technical solutions of the present invention instead of limiting the scope of it. And those skilled in the art will be able to make simple modifications or equivalent alterations to the technical solutions of the present invention without departing from the spirit and scope of the technical solution of the present invention.

1. An atomizer of an electronic cigarette comprises an airflow channel, a conductive line, an oil storage apparatus and an atomization core, wherein the airflow channel comprises an air inlet end and an air outlet end, the atomization core comprises a liquid seepage member, an electric heating body and an atomization core housing, and the liquid seepage member and the electric heating body are arranged in the atomization core housing; the liquid seepage member is in communication with the oil storage apparatus; the airflow channel is in communication with the atomization core; the oil storage apparatus is an oil storage bottle which is integrally formed and a bottle coveris arranged on the oil storage bottle; the bottle covercomprises a gas and electricity conducting tube arranged under the bottle cover; one end of the atomization core is detachably connected with the gas and electricity conducting tube; the atomization core is arranged in the oil storage bottle; the conductive line is conducting to the electric heating body from the bottle cover, then the electric heating body is transmitted back to the bottle cover through the gas guide conductive pipe to complete a loop and the air guide conductive tube completes the loop butt joint of air inlet and air outlet of the atomization core.

2. An atomizer of an electronic cigarette according to the claim 1, wherein the gas guide conductive pipe comprises a first pipe and a second pipe; the first pipe is arranged on the periphery of the second pipe; on the atomization core are respectively arranged an atomization core air inlet and an atomization core air outlet; the first pipe is connected with the atomization core air inlet; and the second pipe is connected with the atomization core air outlet.

3. An atomizer of an electronic cigarette according to the claim 1, wherein the gas and electricity conducting tube comprises a first pipe and a second pipe; the first pipe is arranged inside the second pipe; and the airflow channel comprises the first pipe and a breather pipe formed between the first pipe and the second pipe.

4. An atomizer of an electronic cigarette according to the claim 3, further comprising a cylinder shell, wherein the oil storage bottle is arranged inside the cylinder shell, and below the cylinder shell is arranged a joint; the cylinder shell comprises an outer cylinder shell, an inner cylinder shell and an insulation tube; the bottle cover comprises an cover housing, an inner cover housing and an insulation layer, the insulating tube is arranged between the outer cylinder shell and the inner cylinder shell; the insulation layer is arranged between cover housing and an inner cover housing; the conductive line comprises an outer cylinder shell, an inner cylinder shell, a cover housing and an inner cover housing, and the outer cylinder shell, the inner cylinder shell, the cover housing and the inner cover housing are all made of conductive materials; the outer cylinder shell and the inner cylinder shell are electrically connected with the joint;one end of the outer cylinder shell is electrically connected with the inner cover housing; one end of the inner cylinder shell is electrically connected with the cover housing, one end of the electric heating body is electrically connected with the cover housingand the other end of the electric heating body thereof is electrically connected with the inner cover housing.

5. An atomizer of an electronic cigarette according to the claim 4, wherein the second pipe and the first pipe are made of conductive materials; the second pipe is fixedly connected with the inner cover housing, and the first pipe is fixedly connected with the cover housing.

6. An atomizer of an electronic cigarette according to the claim 5, wherein an adjusting ring is sleeved onto the cover housing and the adjusting ring is provided with air inlet holes; the air inlet end is arranged on the bottle cover; the air inlet end includes a first air inlet end arranged on the cover housing, a second air inlet end arranged on the insulation layer and a third air inlet end arranged on the inner cover housing; the cover housing is provided with a pin which is inserted through air inlet holes and arranged onto the cover housing; the air outlet end is an air outlet hole arranged on the bottle cover; the air outlet hole is communicated with the first pipe or the breather pipe; and the air outlet hole is internally provided thereon with screw threads.

7. An atomizer of an electronic cigarette according to the claim 5, wherein an inner air inlet end is arranged on the inner cover housing; an outer air inlet end is arranged on the joint and communicated with the inner air inlet end; and the inner air inlet end is communicated with an air flow channel.

8. An atomizer of an electronic cigarette according to the claim 6, wherein on the bottom of the oil storage bottle is arranged a concave cylinder which wraps the bottom of the atomization core housing, and above the concave cylinder is arranged the oil inlet hole.

9. An atomizer of an electronic cigarette according to the claim 8, wherein on the cylinder shell is arranged a viewing aperture which comprises an inner cylinder shell, an insulation tube, and a first viewing aperture, a second viewing aperture and a third viewing aperture respectively arranged on the outer cylinder shell.

10. An atomizer of an electronic cigarette according to the claim 9, wherein scale marks are engraved on the oil storage bottle.

11. An atomizer of an electronic cigarette according to the claim 10, wherein the airflow channel is provided with an airflow sensing element.

12. An atomization core matched with the atomizer of an electronic cigarette according to the claim 1, comprising a liquid seepage member, an electric heating body and an atomization core housing, wherein the atomization core housing is internally provided with an inner tube, at the bottom of the inner tube is internally arranged a shim block; the wall of the inner tube is provided with a long strip opening, and an electric heating body and a liquid seepage member are arranged inside the inner tube; the atomization core housing and the inner tube are respectively distributed with first oil inlet holes and second oil inlet holes, the first oil inlet holes are aligned with second oil inlet holes; the liquid seepage member is arranged on the inner wall of the inner tube in a tubular shape and on the shim block; and the electric heating body is arranged inside the tubular liquid seepage member in a spring shape.

13. An atomization core matched with an atomizer of an electronic cigarette according to claim 12, wherein the nozzle of the inner tube is provided with a seal ring, and inside the seal ring is sleeved a conductive component.

14. An atomizer of an electronic cigarette according to the claim 7, wherein on the bottom of the oil storage bottle is arranged a concave cylinder which wraps the bottom of the atomization core housing, and above the concave cylinder is arranged the oil inlet hole.
